(19) United States
(12) Patent Application Publication
(10) Pub. No.: US 2008/0026264 A1
(43) Pub. Date: Jan. 31, 2008

(54) Fuel cell system and operation control method therefore

(76) Inventor: Daisuke Watanabe, Ome-shi (JP)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/880,962

(22) Filed: Jul. 24, 2007

(30) Foreign Application Priority Data
Jul. 28, 2006 (JP) 2006-206701

(51) Int. Cl. H01M 8/00; H01M 8/04

(52) U.S. Cl. 429/13; 429/22; 429/23

(57) ABSTRACT

According to one embodiment, a fuel cell system includes a plurality of cell stacks, each of which includes a plurality of single cells, stacked in layers on one another and each including an anode and a cathode opposed to each other, a fuel passage through which a fuel is supplied to the anode, and an air passage through which air is supplied to the cathode, and generates electric power based on a chemical reaction. There are provided an air pump which supplies air to the plurality of cell stacks, and a valve mechanism arranged between the air pump and the air passage of each cell stack, which switches a flow distribution of air from the air pump to each cell stack. A power controller shifts the valve mechanism to change the flow distribution to the plurality of cell stacks.

### CROSS-REFERENCE TO RELATED APPLICATIONS

This application is based upon and claims the benefit of priority from Japanese Patent Application No. 2006-206701, filed Jul. 28, 2006, the entire contents of which are incorporated herein by reference.

### BACKGROUND

1. Field

One embodiment of the present invention relates to a fuel cell system provided with a fuel cell unit for use as a power source for an electronic device or the like and an operation control method therefor.

2. Description of the Related Art

Presently, secondary batteries, such as lithium ion batteries, are mainly used as power sources for portable notebook personal computers (notebook PCs), mobile devices, etc. In recent years, small-sized, high-output fuel cells that require no charging have been expected as new power sources to meet the demands for increased power consumption and prolonged use of these electronic devices with higher functions. Among various types of fuel cells, direct methanol fuel cells (DMFCs) that use a methanol solution as a fuel, in particular, enable easier handling of the fuel and a simpler system configuration, as compared with fuel cells that use hydrogen as their fuel. Thus, the DMFCs are noticeable power sources for the electronic devices.

As disclosed in Jpn. Pat. Appln. KOKAI Publication No. 2005-293981, for example, a fuel cell usually has a cell stack composed of single cells and separators that are alternately stacked in layers. Each single cell is composed of an electrolyte layer, such as an electrolyte plate or a solid polymer electrolyte membrane permeable to hydrogen ions (protons), which is sandwiched between two electrodes. Each separator has a groove for use as a reaction gas passage. Each single cell is provided with a membrane electrode assembly (MEA), which integrally includes an anode (fuel electrode) and a cathode (air electrode) each formed of a catalyst layer and a carbon paper. The anode and the cathode are disposed individually on the opposite surfaces of a polymer electrolyte membrane. An aqueous methanol solution with a concentration of several to tens of percent is supplied to the anode through a passage in the cell stack, and air to the cathode.

Oxidation of a fuel occurs in the anode. Specifically, methanol is oxidized by reaction with water, whereupon carbon dioxide, protons, and electrons are produced. The protons move to the cathode through the polymer electrolyte membrane. In the cathode, oxygen gas in the air is combined with hydrogen ions and electrons and reduced to generate water. As this is done, the electrons flow into an external circuit, and current is extracted.

In constructing the fuel cell system using the cell stack arranged in this manner, a plurality of cell stacks may be set in the system and connected in parallel with one another in consideration of the improvement of outputs or mounting conditions, in some cases. In this system, an output voltage from the parallel connection is fixedly adjusted to the voltage of the highest-voltage cell stack. Therefore, currents generated from cell stacks with lower output voltages are relatively low, so that output currents are supplied mainly from cell stacks with higher output voltages.

In a proposed system described in Jpn. Pat. Appln. KOKAI Publication No. 6-267577, for example, output power is detected for each cell stack, and the degree of valve opening is regulated to adjust the air and fuel supply rates for each cell stack, depending on the output voltage, in order to equalize the values of the output currents from the cell stacks.

In the fuel cell system constructed in this manner, however, an air passage and a fuel passage of each cell stack must be provided with supply- and exhaust-side valves such that the degrees of opening of the four valves are adjusted in accordance with an output voltage value of each cell stack. Therefore, the configuration and control of the entire system are complicated.

On the other hand, a fuel cell may be subjected to a phenomenon called “flooding” such that water produced at the air electrode by power generation increases and stands in the passages, thereby inhibiting a power generation reaction. In order to prevent this phenomenon, the output of the fuel cell may possibly be recovered by blowing off the standing water with a larger amount of air than in normal operation that is temporarily run against the air electrode. In this recovery processing, it is more effective to operate an air pump at a rotational frequency higher than in the normal operation. In this case, however, the air pump is expected to have higher specifications and an increased size that are not required by the normal operation. Thus, the fuel cell system is inevitably increased in size and cost.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary perspective view showing a fuel cell unit of a fuel cell system according to an embodiment of the invention;

FIG. 2 is an exemplary perspective view showing the fuel cell system;

FIG. 3 is an exemplary system diagram mainly showing the internal structure of a power generator of the fuel cell unit;

FIG. 4 is an exemplary sectional view showing a DMFC stack of the fuel cell unit;

FIG. 5 is an exemplary view schematically showing a single cell of the DMFC stack;

FIG. 6 is an exemplary system diagram showing a state in which an information processor is connected to the fuel cell unit;

FIG. 7 is an exemplary system diagram showing the configuration of the fuel cell unit and the information processor;

FIGS. 8A, 8B and 8C are exemplary block diagrams showing flow distributions of air corresponding to shift positions of a switching valve during operation for recovery processing;

FIG. 9 is a flowchart showing a recovery processing operation for the fuel cell system;

FIG. 10 is an exemplary flowchart showing another recovery processing operation for the fuel cell system;

FIGS. 11A, 11B and 11C are exemplary block diagrams showing flow distributions of a fuel and air corresponding to shift positions of switching valves in a low-output operation mode;

FIG. 12 is an exemplary diagram showing outputs and operating efficiencies of stacks for three-, two-, and one-stack operations;

FIG. 13 is an exemplary flowchart showing the low-output operation mode of the fuel cell system; and

FIGS. 14A, 14B and 14C are exemplary block diagrams showing flow distributions of a fuel and air corresponding to shift positions of switching valves in a low-output operation mode in a fuel cell system according to another embodiment of the invention.

### DETAILED DESCRIPTION

Various embodiments according to the invention will be described hereinafter with reference to the accompanying drawings. In general, according

to one embodiment of the invention, a fuel cell system comprises: a plurality of cell stacks, each of which includes a plurality of single cells, stacked in layers on one another and each including an anode and a cathode opposed to each other, a fuel passage through which a fuel is supplied to the anode, and an air passage through which air is supplied to the cathode, and generates electric power based on a chemical reaction; an air pump which supplies air to the plurality of cell stacks; a valve mechanism which is provided between the air pump and the air passage of each cell stack and switches a flow distribution of air from the air pump to each cell stack; and a power controller which shifts the valve mechanism to change the flow distribution to the plurality of cell stacks.

According to another embodiment of the invention, a method of controlling an operation of a fuel cell system, which comprises a plurality of cell stacks, each of which includes a plurality of single cells, stacked in layers on one another and each including an anode and a cathode opposed to each other, a fuel passage through which a fuel is supplied to the anode, and an air passage through which air is supplied to the cathode, and generates electric power based on a chemical reaction, an air pump which supplies air to the plurality of cell stacks, a valve mechanism which is provided between the air pump and the air passage of each cell stack and switches a flow distribution of air from the air pump to each said cell stack, and a power controller which shifts the valve mechanism to change the flow distribution to the plurality of cell stacks, the method comprises: uniformly distributing the air from the air pump to the plurality of cell stacks during normal operation, thereby performing operation for power generation; and shifting the valve mechanism to stop air supply from the air pump to at least one of the cell stacks during recovery processing and distributing the air from the air pump to the other cell stacks only, to recover the other cell stacks.

A fuel cell system according to an embodiment of the present invention will now be described in detail with reference to the accompanying drawings.

The fuel cell system according to the present embodiment is provided with a fuel cell unit and an information processor, e.g., a notebook personal computer, which receives electric power supply from the fuel cell unit.

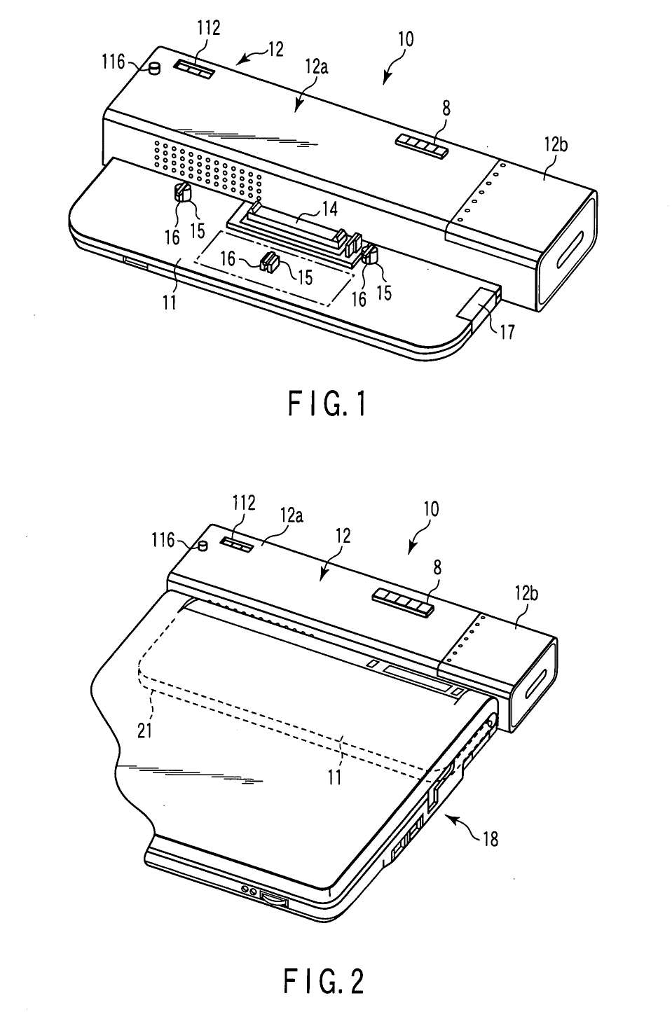

FIG. 1 is an exemplary external view showing a fuel cell unit 10, and FIG. 2 is an exemplary external view showing the fuel cell unit and an information processor 18 connected to it. As shown in FIG. 1, the fuel cell unit 10 is provided with a mounting platform 11 on which the rear part of the information processor is set and a fuel cell unit body 12. As described later, the fuel cell unit body 12 contains therein a DMFC stack for power generation based on an electrochemical reaction and various accessories for injecting into and circulating methanol and air that form a fuel in the DMFC stack.

The fuel cell unit body 12 includes a unit case 12a, and a removable fuel cartridge is held in, for example, the left-hand end part of the unit case. A part of the unit case 12a constitutes a detachable cover 12b that facilitates the fuel cartridge to be replaced with a new one.

A power generation setting switch 112 and a fuel cell operation switch 116 are provided on, for example, one end portion of the upper surface of the unit case 12a. A plurality of indicators 8 are arranged on the central part of the upper surface of the unit case 12a. They serve as indicating means that indicate the operating state of the fuel cell unit 10 and the presence of the fuel in the fuel cartridge.

The power generation setting switch 112 is a switch that is preset by a user to allow or prohibit power generation in the fuel cell unit 10. For example, it is composed of a slide-type switch. The fuel cell operation switch 116 is used, for example, to stop only the power generation in the fuel cell unit 10 without interrupting the operation of the information processor 18 while the processor 18 is being operated by electric power supplied from the unit 10. In this case, the operation of the information processor 18 is continued by using power from a built-in secondary battery. For example, the operation switch 116 is composed of a push switch.

The mounting platform 11 has a flat rectangular shape, extending horizontally from the unit case 12a so that the rear part of the information processor 18 can be placed on it. A docking connector 14 for use as a junction for connection with the processor 18 is provided on the upper surface of the platform 11. A docking connector 21 (mentioned later) for use as a junction for connection with the fuel cell unit 10 is provided on, for example, the rear part of the bottom surface of processor 18. When the rear part of the information processor 18 is set on the mounting platform 11, the docking connectors 14 and 21 are connected mechanically and electrically to each other.

Positioning projections 15 and hooks 16 that constitute a locking mechanism are disposed on three spots of the mounting platform 11. The projections 15 and the hooks 16 individually engage engaging holes (not shown) in the rear part of the bottom surface of the information processor 18, thereby positioning and holding the information processor with respect to the mounting platform 11. The mounting platform 11 is provided with an eject button 17, which is used to unlock the locking mechanism in removing the processor 18 from the fuel cell unit 10.

The shape and size of the fuel cell unit 10 shown in FIGS. 1 and 2, the shape and position of the docking connector 14, etc. may be modified variously.

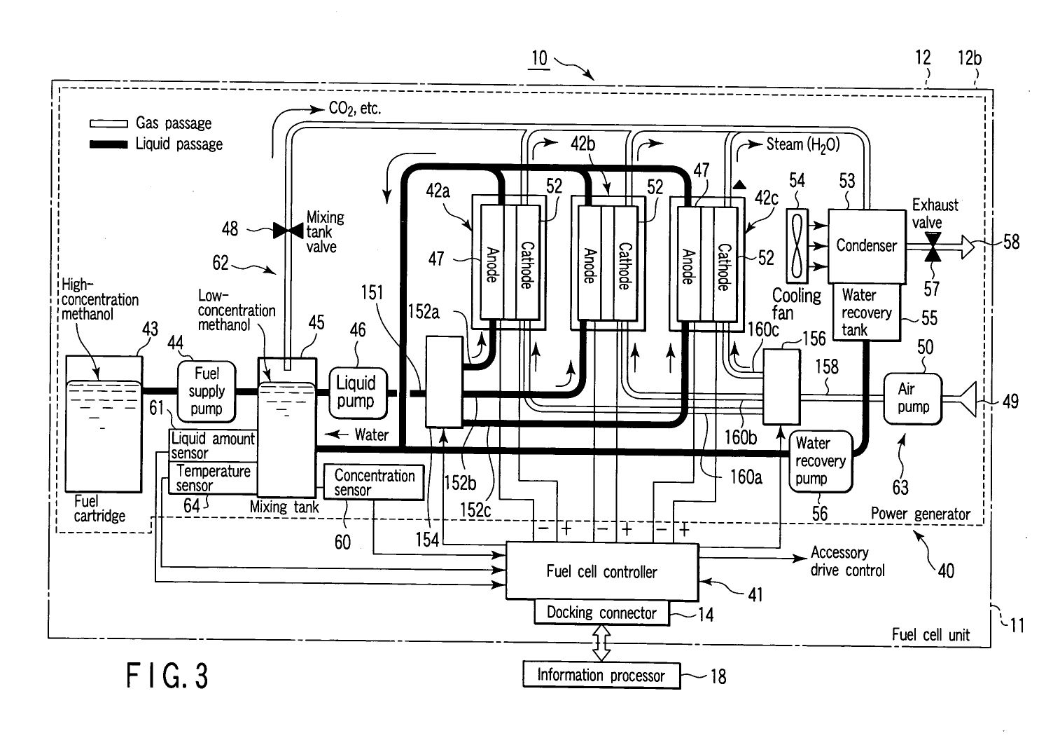

FIG. 3 is an exemplary system diagram showing the fuel cell unit 10 and illustrates detailed systems for the DMFC stack and accessories around it, in particular.

The fuel cell unit 10 is provided with a power generator 40 and a fuel cell controller 41 for use as control means for the unit 10. The controller 41 controls the generator 40, and besides, serves as a communication control section for communication with the information processor 18.

The power generator 40 is provided with a fuel cartridge 43 stored with methanol as the fuel, as well as a plurality of, e.g., three, DMFC stacks 42a, 42b and 42c that primarily serve for power generation. High-concentration methanol is sealed in the cartridge 43. The cartridge 43 is configured to be removable so that it can bee easily replaced with a new one when the fuel therein is used up.

In a direct-methanol fuel cell, a crossover phenomenon must be reduced in order to improve the power generation efficiency. For this purpose, it is effective to dilute the high-concentration methanol to a lower concentration and inject it into a fuel electrode 47. To attain this, the fuel cell unit 10 uses a dilution/circulation system 62, and the power generator 40 is provided with accessories 63 that are needed to realize the system 62.

The dilution/circulation system 62 is provided with a liquid passage through which the fuel and other fluids are run and a gas passage through which air and other gases are allowed to flow. The accessories 63 include ones provided in the liquid passage and ones in the gas passage.

The accessories 63 in the liquid passage include a fuel supply pump 44 that is pipe-connected to an output portion of the fuel cartridge 43, a mixing tank 45 connected to an output portion of the pump 44, and a liquid pump 46 connected to an output portion of the mixing tank 45. An output portion of the pump 46 is connected to respective anodes (fuel electrodes) 47 of the DMFC stacks 42a, 42b and 42c. An output portion of the anode 47 of each DMFC stack is pipe-connected to the mixing tank 45.

A fuel supply line that constitutes a part of the liquid passage has a main passage 151 extending from the liquid pump 46 and three branch lines 152a, 152b and 152c, which diverge from the main passage and extend to the anodes 47 of the three DMFC stacks 42a, 42b and 42c, respectively. A four-way valve 154 is located at a junction between the main passage 151 and the branch lines 152a, 152b and 152c. The valve 154 is shifted between a plurality of operating positions under the control of the fuel cell controller 41, whereby flow distributions of the fuel supplied from the liquid pump 46 to the three DMFC stacks 42a, 42b and 42c can be changed.

Specifically, the four-way valve 154 is constructed as a solenoid valve, for example, through which the fuel supplied through the main passage 151 from the liquid pump 46 can be uniformly distributed to the three branch lines 152a, 152b and 152c. Thus, the four-way valve 154 can be shifted between a normal operating position in which the fuel is supplied to the three DMFC stacks 42a, 42b and 42c, three first shift positions in which the fuel is distributed to two remaining branch lines with one branch line closed, and three second shift positions in which the fuel is distributed to one remaining branch line with two other branch lines closed.

Further, the accessories 63 include a water recovery tank 55 that is disposed adjacent to a condensed gas 3 (mentioned later). An output portion of the tank 55 is pipe-connected to a water recovery pump 56. An output portion of the pump 56 is connected to the mixing tank 45. The fuel cartridge 43, fuel supply pump 44, mixing tank 45, and liquid pump 46 constitute a fuel supply section that supplies the fuel to the DMFC stacks 42a, 42b and 42c.

The accessories 63 in the gas passage include an air pump 50, a four-way valve 156, and a condenser 53. The air pump 50 is connected to respective cathodes (air electrodes) 52 of the DMFC stacks 42a, 42b and 42c through an air supply line that constitutes a part of the gas passage. The four-way valve 156 is attached to the air supply line so as to be situated between the air pump and the DMFC stacks. The condenser 53 is connected to respective output portions of the cathodes 52. Further, the mixing tank 45 is pipe-connected to the condenser 53 through a mixing tank valve 48. The condenser 53 is connected to an exhaust port 58 through an exhaust valve 57. The condenser 53 is provided with fins that effectively condense steam. A cooling fan 54 is located opposite the condenser 53.

The air supply line that constitutes a part of the gas passage has a main passage 158 extending from the air pump 50 and three branch lines 160a, 160b and 160c, which diverge from the main passage and extend to the cathodes 52 of the three DMFC stacks 42a, 42b and 42c, respectively. The four-way valve 156 is located at a junction between the main passage 158 and the branch lines 160a, 160b and 160c. The valve 156 is shifted between a plurality of operating positions under the control of the fuel cell controller 41, whereby flow distributions of the air supplied from the air pump 50 to the three DMFC stacks 42a, 42b and 42c can be changed.

Specifically, the four-way valve 154 is constructed as a solenoid valve, for example, through which air supplied through the main passage 158 from the air pump 50 can be uniformly distributed to the three branch lines 160a, 160b and 160c. Thus, the four-way valve 154 can be shifted between a normal operating position in which air is supplied to the three DMFC stacks 42a, 42b and 42c, three first shift positions in which air is distributed to two remaining branch lines with one branch line closed, and three second shift positions in which air is distributed to one remaining branch line with two other branch lines closed.

The three DMFC stacks 42a, 42b and 42c that are provided as cell stacks have the same configuration. Therefore, the configuration of the DMFC stack 42a will now be described as a representative.

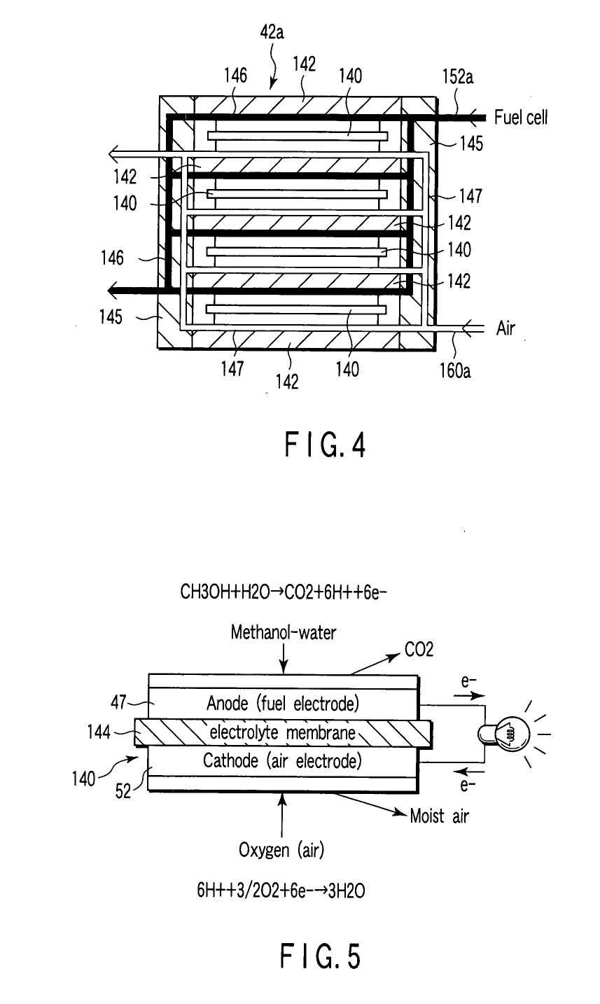

As shown in FIGS. 4 and 5, the DMFC stack 42a has a cell stack and a frame 145 that supports the cell stack. The stack structure includes a plurality of, e.g., four, single cells 140 and five separators 142 in the form of rectangular plates, which are alternately stacked in layers. Each single cell 140 is provided with a membrane electrode assembly (MEA), which integrally includes the cathode 52 and the anode 47, each in the form of a rectangular plate composed of a catalyst layer and a carbon paper, and a substantially rectangular polymer electrolyte membrane 144 sandwiched between the cathode and the anode. The polymer electrolyte membrane 144 is formed with an area larger than those of the cathode 52 and the anode 47.

Three of the separators 142 are stacked in layers, each between two adjacent single cells 140, while the other two separators are stacked individually at the opposite ends with respect to the stacking direction. The separators 142 and the frame 145 are formed having a fuel passage 146 for fuel supply to the anode 47 of each single cell 140 and an air passage 147 for air supply to the cathode 52 of the single cell.

The power generation mechanism of the power generator 40 of the fuel cell unit 10 will now be described along flows of the fuel and air (oxygen).

First, as shown in FIG. 3, the high-concentration methanol in the fuel cartridge 43 is supplied to the mixing tank 45 by the fuel supply pump 44. In the mixing tank 45, the high-concentration methanol is mixed with recovered water, low-concentration methanol (residue of power generation reaction) from the anode 47, etc. and diluted, whereupon low-concentration methanol is produced. The low-concentration methanol is controlled so that it can maintain a concentration of, e.g., 3 to 6% for a high power generation efficiency. This concentration control is achieved as the fuel cell controller 41 controls the amount of high-concentration methanol supplied to the mixing tank 45 by the fuel supply pump 44 in accordance with, for example, the result of detection by a concentration sensor 60. Alternatively, the concentration control may be realized by controlling the amount of circulating water in the mixing tank 45 by means of the water recovery pump 56 or the like.

The mixing tank 45 is provided with a liquid amount sensor 61 for detecting the amount of an aqueous methanol solution in the mixing tank 45 and a temperature sensor 64 for temperature detection. Results of detection by these sensors are delivered to the fuel cell controller 41 and used for the control of the power generator 40 and the like.

The aqueous methanol solution diluted in the mixing tank 45 is compressed by the liquid pump 46 and fed to the three DMFC stacks 42a, 42b and 42c through the main passage 151, the four-way valve 154, and the branch lines 152a, 152b and 152c. In each of the DMFC stacks 42a, 42b and 42c, the aqueous methanol solution is fed into the fuel passage 146, through which it is injected into the anode 47 of each single cell 140. In the anode 47, as shown in FIG. 5, electrons are generated as the methanol is oxidized. Hydrogen ions (H+) generated by the oxidation reaction are transmitted through the solid polymer electrolyte membrane 144 in each of the DMFC stacks 42a, 42b and 42c and reach the cathode 52.

Carbon dioxide that is generated by the oxidation reaction at the anode 47, along with an unoxidized portion of the aqueous methanol solution, is refluxed again into the mixing tank 45. The carbon dioxide is gasified in the mixing tank 45, fed through the gas passage into the condenser 53, and finally, discharged to the outside through the exhaust valve 57 and the exhaust port 58.

As shown in FIG. 3, on the other hand, air (oxygen) is introduced through an intake port 49 and compressed by the air pump 50 that constitutes an air supply section. Thereafter, it is fed to the DMFC stacks 42a, 42b and 42c through the main passage 158, the four-way valve 156, and the three branch lines 160a, 160b and 160c. In each of the DMFC stacks 42a, 42b and 42c, air that is fed into the air passage 147 is supplied through the air passage to the cathode (air electrode) 52 of each single cell 140. At the cathode 52, reduction of oxygen (O²) advances, whereupon electrons (e⁻) from an external load, hydrogen ions (H⁺) from the anode 47, and oxygen (O²) produce water (H²O) in the form of steam. This steam is discharged from the cathode 52 and gets into the condenser 53. In the condenser 53, the steam is cooled by the cooling fan 54 to water (liquid), which is temporarily stored in the water recovery tank 55. The recovered water is refluxed into the mixing tank 45 by the water recovery pump 56 and forms the dilution/circulation system 62 for diluting the high-concentration methanol.

As seen from this power generation mechanism of the fuel cell unit 10 based on the dilution/circulation system 62, the accessories 63, including the pumps 44, 46, 50 and 56, the valves 48, 51 and 57, the cooling fan 54, etc., are driven to take out electric power from the DMFC stacks 42, that is, to start power generation. Thus, the aqueous methanol solution and air (oxygen) are injected into the DMFC stacks 42, whereupon an electrochemical reaction advances to generate electric power. The electric power generated in the DMFC stacks 42 is supplied to the information processor 18 through the fuel cell controller 41 and the docking connector 14. In stopping the power generation, on the other hand, the drive of the accessories 63 or the takeout of the electric power from the DMFC stacks 42 is stopped.

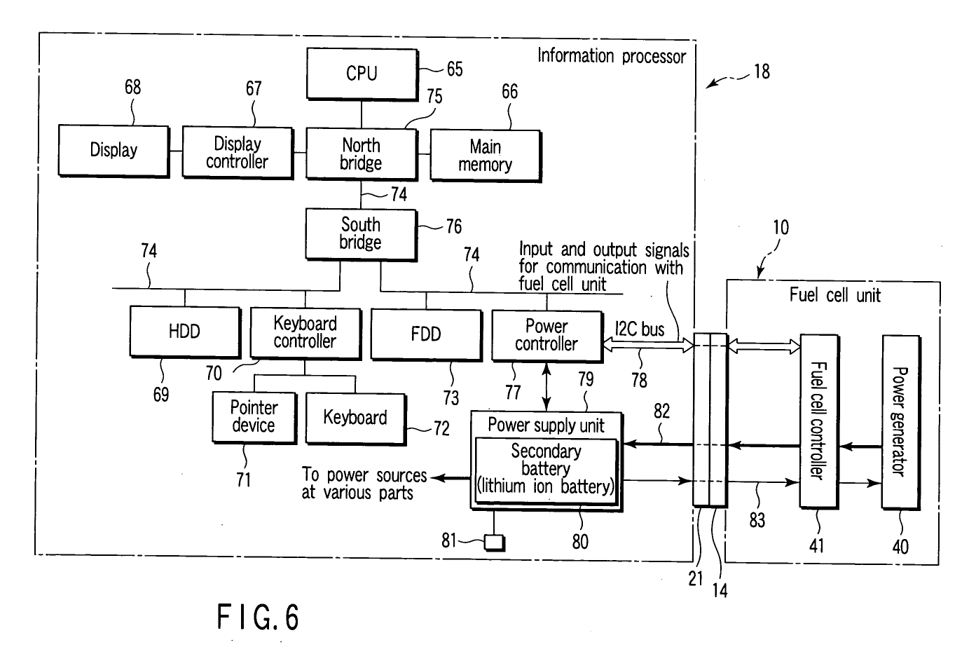

FIG. 6 shows an exemplary system configuration of the information processor 18 to which the fuel cell unit 10 according to the present embodiment is connected.

The information processor 18 is provided with a CPU 65, main memory 66, display controller 67, display 68 as a display section, hard disc drive (HDD) 69, keyboard controller 70, pointer device 71, keyboard 72 as a input section, and FDD 73. The processor 18 is further provided with a bus 74 that transfers signals between these components, north and south bridges 75 and 76 for converting the signals transferred through the bus 74, and the like. Furthermore, a power supply unit 79, which holds therein a secondary battery 80, such as a lithium ion battery, is disposed in the information processor 18. The power supply unit 79 is controlled by a power controller 77.

The CPU 65 serves to control the operation of the entire information processor 18, and it executes various programs for an operating system (OS), utility software including a power management utility, application software, etc. that are stored in the main memory 66.

A control-system interface and a power-system interface are provided as electrical interfaces between the fuel cell unit 10 and the information processor 18. The control-system interface is an interface for communication between the power controller 77 of the information processor 18 and the fuel cell controller 41 of the fuel cell unit 10. The communication between the processor 18 and the unit 10 through the control-system interface is made by means of a serial bus, such as an I2C bus 78.

The power-system interface is an interface for power transfer between the fuel cell unit 10 and the information processor 18. For example, electric power generated by the DMFC stack 42 of the power generator 40 is supplied to the information processor 18 through the fuel cell controller 41 and the docking connectors 14 and 21. The power-system interface also includes a power supply 83 from the power supply unit 79 of the processor 18 to the accessories 63 in the fuel cell unit 10.

DC source power, obtained by AC/DC conversion, is supplied to the power supply unit 79 of the information processor 18 through an AC adapter connector 81, whereby the processor 18 can be activated, and the secondary battery 80 can be charged.

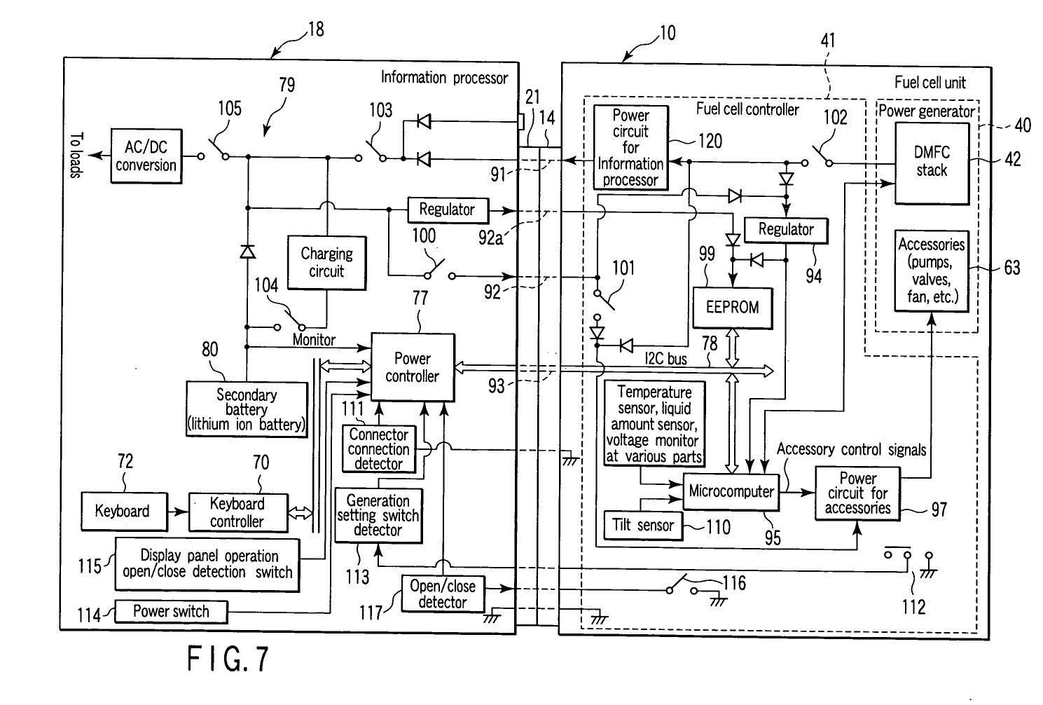

FIG. 7 is an exemplary configuration diagram showing connection between the fuel cell controller 41 of the fuel cell unit 10 and the power supply unit 79 of the information processor 18.

The fuel cell unit 10 and the information processor 18 are connected mechanically and electrically to each other by the docking connectors 14 and 21. The docking connectors 14 and 21 are provided with a first power terminal (output power terminal) 91 and a second power terminal (input power terminal for accessories) 92. Electric power generated by the DMFC stacks 42a, 42b and 42c of the fuel cell unit 10 is supplied to the information processor 18 through the first power terminal 91. The second power terminal 92 is used when source power is supplied from the processor 18 to a microcomputer 95 of the fuel cell unit 10 through a regulator 94 and when source power is supplied to a power circuit 97 for accessories through a switch 101. Further, the docking connectors 14 and 21 have a third power terminal 92a through which source power is supplied from the processor 18 to a writable nonvolatile memory (EEPROM) 99.

Furthermore, the docking connectors 14 and 21 have a communication input/output terminal 93 for communication between the power controller 77 of the information processor 18 and the microcomputer 95 of the fuel cell unit 10 or the EEPROM 99. The microcomputer 95 serves also as a detector for detecting the output power of the DMFC stacks 42a, 42b and 42c. The detected output power, e.g., an output current value in this case, is loaded into the EEPROM 99.

Referring now to FIG. 7, there will be described a basic flow of processing such that electric power generated by the DMFC stacks 42a, 42b and 42c of the fuel cell unit 10 is supplied from the unit 10 to the information processor 18. Now let it be supposed that the secondary battery (lithium ion battery) 80 of the information processor 18 is charged with predetermined electric power and that all the switches shown in FIG. 7 are open.

Based on a signal outputted from a connector connection detector 111, the information processor 18 recognizes that it is connected mechanically and electrically to the fuel cell unit 10. This recognition is made as the connection detector 111 detects, based on an input signal received thereby, for example, that it is grounded in the fuel cell unit 10 when the docking connectors 14 and 21 are connected to each other.

The power controller 77 of the information processor 18 determines whether the power generation setting switch 112 is set in a generation permitting mode or a generation prohibiting mode. In response to an input signal received by a generation setting switch detector 113, for example, the detector 113 detects whether the power generation setting switch 112 is grounded or open, depending on the setting state of the switch 112. If the switch 112 is open, the power controller 77 concludes that the generation prohibiting mode is established.

When the information processor 18 and the fuel cell unit 10 are mechanically connected to each other by the docking connectors 14 and 21, source power is supplied from the processor 18 to the EEPROM 99 as a memory section of the fuel cell controller 41 through the third power terminal 92a. The EEPROM 99 is previously stored with status information on the fuel cell unit 10 and the like. The status information may include, for example, a parts code, serial number, or rated output of the fuel cell unit 10, detected output current values of the DMFC stacks 42a, 42b and 42c, and detected data, such as the liquid amount, temperature, concentration, etc., detected by the various sensors. The EEPROM 99 is connected to a serial bus, such as the I2C bus 78, and data stored in the EEPROM 99 can be read while the source power is being supplied to the EEPROM 99. The power controller 77 can read the status information from the EEPROM 99 through the communication input/output terminal 93 and store it into a built-in register or the like.

In this state, the fuel cell unit 10 is not performing power generation, and its interior is kept so that no source power than that for the EEPROM 99 is supplied.

If the user sets the power generation setting switch 112 in the generation permitting mode, the power controller 77 in the information processor 18 is enabled to read identification information stored in the EEPROM 99 in the fuel cell unit 10. Preferably, the power generation setting switch should be a slide switch or any other suitable switch that can be kept open or closed.

If it is concluded, based on the identification information read from the EEPROM 99 in the fuel cell unit 10, that the unit 10 connected to the information processor 18 is compatible with the processor 18, the power controller 77 closes a switch 100 that is attached to the processor 18. Thereupon, electric power from the secondary battery 80 is supplied to the fuel cell unit 10 through the second power terminal 92, and source power is supplied to the microcomputer 95 through the regulator 94. In this state, the switch 101 in the fuel cell unit 10 is open, and no source power is supplied to the power circuit 97 for accessories. Thus, the accessories 63 are not operating in this state.

However, the microcomputer 95, having already started operation, is ready to receive various control commands from the power controller 77 of the information processor 18. Further, the microcomputer 95 is ready to transmit power supply information of the fuel cell unit 10 to the processor 18.

When a generation start command is delivered from the power controller 77 to the fuel cell controller 41 in this state, the controller 41 having received this command closes the switch 101 under the control of the microcomputer 95, whereupon source power is supplied from the information processor 18 to the power circuit 97 for accessories. In response to accessory control signals transmitted from the microcomputer 95, at the same time, the controller 41 drives the accessories 63 in the power generator 40, that is, the pumps 44, 46, 50 and 56, valves 48, 51 and 57, cooling fan 54, etc. The microcomputer 95 closes a switch 102 in the fuel cell controller 41.

In consequence, the aqueous methanol solution and air are injected into the DMFC stacks 42a, 42b and 42c in the power generator 40, and power generation is started. In normal operation, the microcomputer 95 keeps the four-way valves 154 and 156 in their respective normal operating positions and equally supplies the fuel and air to the three DMFC stacks 42a, 42b and 42c. Electric power generated by the DMFC stacks 42a, 42b and 42c starts to be supplied to the information processor 18 through an information processor power circuit 120 in the fuel cell controller 41. Since the generated power output cannot instantaneously reach a rated value, however, a warm-up mode is maintained so that the rated value is reached.

The microcomputer 95 of the fuel cell controller 41 monitors, for example, the respective output voltages and temperatures of the DMFC stacks 42a, 42b and 42c. When it concludes that rated values are reached by the outputs of the stacks 42a, 42b and 42c, the microcomputer 95 opens the switch 101 of the fuel cell unit 10, thereby switching the source of power supply to the accessories 63 from the information processor 18 to the DMFC stacks 42a, 42b and 42c.

The following is a description of an appropriate method of recovery processing for lowered output of each DMFC stack 42.

If water mainly produced at the cathodes 52 of the single cells 140 that constitute the DMFC stack 42 stands in the air passage 147 of the stack 42, thereby preventing air from permeating into the cells 140, owing to prolonged use of the fuel cell unit 10, for example, the balance of fuel and air supply is broken, so that the output current value or generated power output of the DMFC stack 42 is reduced. If the power generation is continued in a low-output state, the efficiency of power supply lowers, and the heat generation rate increases, possibly resulting in breakage of the cells.

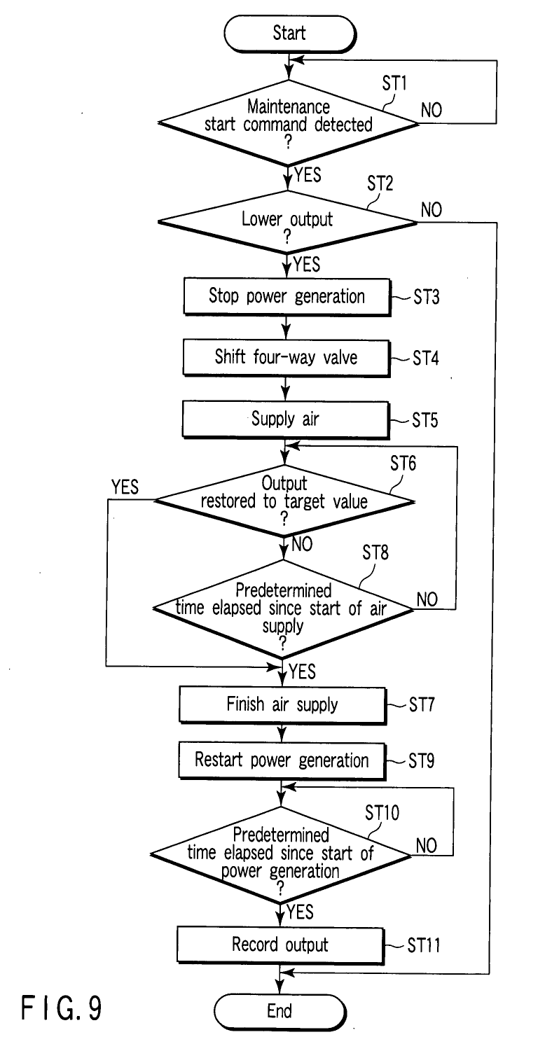

Thus, according to the fuel cell system, recovery processing for the fuel cell unit 10 is carried out if such an output reduction occurs or at the user's desired timing. Operation for the recovery processing will now be described with reference to the flowchart of FIG. 9.

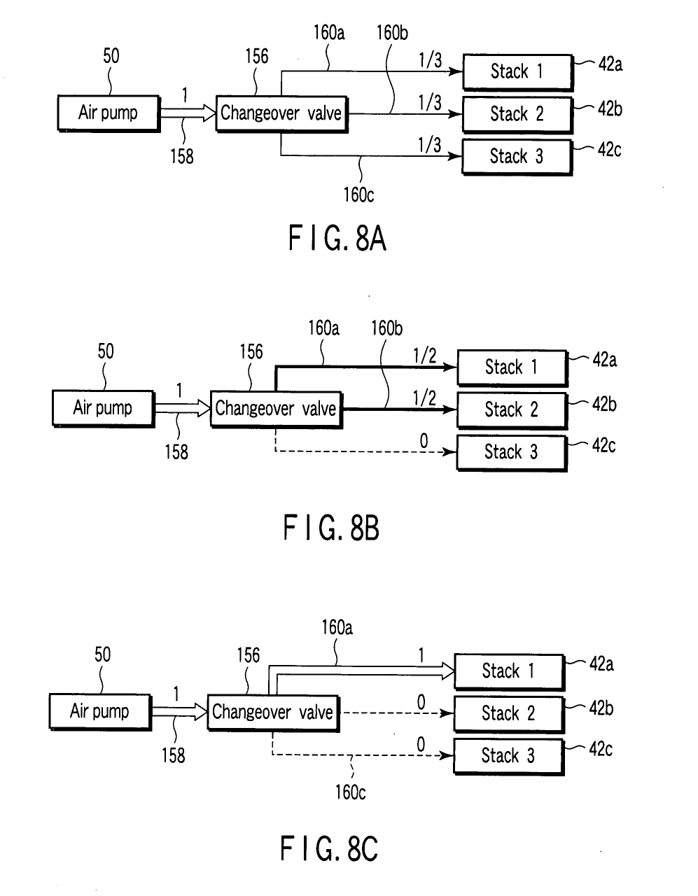

In the normal operation, the four-way valves 154 and 156 are in their normal operating positions. As shown in FIG. 8A, therefore, air supplied from the air pump 50 is uniformly distributed to the three DMFC stacks 42a, 42b and 42c by the four-way valve 156. Thus, if the rate of air supply from the air pump 50 is supposed to be 1, air is equally supplied to each of the DMFC stacks 42a, 42b and 42c at the rate of 1/3.

While operation for power generation by the DMFC stacks 42a, 42b and 42c is being performed, the microcomputer 95 of the fuel cell controller 41 monitors the output current values of the stacks 42a, 42b and 42c, stores the detected output current values into the EEPROM 99, and updates them as required. If the user selects execution of the recovery processing based on the power management utility stored in the main memory 66, a maintenance start command is outputted from the CPU 65 of the information processor 18. Thereupon, a maintenance mode, i.e., the recovery processing, is started.

When the power controller 77 detects the maintenance start command (ST1), as shown in FIG. 9, it fetches the status information on the fuel cell unit 10 from the EEPROM 99 thereof in response to this command. Then, the power controller 77 compares the respective fetched output current values of the DMFC stacks 42a, 42b and 42c with a preset reference output, e.g., a rated output value in this case, and determines whether or not the output current value of any of the stacks 42a, 42b and 42c is lower than the rated output value (ST2).

If the output current value of any of the DMFC stacks is lower by a given or larger margin, the power controller 77 causes the microcomputer 95 of the fuel cell unit 10 to stop power generation in the power generator 40 (ST3). The power generation is stopped by, for example, opening the switch 102 to stop the outputs from the DMFC stacks 42a, 42b and 42c. If none of the output current values of the DMFC stacks 42a, 42b and 42c is lower than the rated output value by the given or larger margin, on the other hand, the maintenance mode is terminated.

After the power generation is stopped, the microcomputer 95 of the fuel cell unit 10, under the control of the power controller 77, drives the air pump 50 of the power generator 40 at the same rotational frequency or air supply rate as in the normal operation, and shifts the four-way valve 156 to a first or second shift position, thereby changing the flow distribution (ST4). If the output current value of the DMFC stack 42a is lowered and if the necessary air supply rate for the recovery processing is about 1.5 times as high as the rate for the normal operation, for example, the microcomputer 95 shifts the four-way valve 156 to the first shift position to close the branch line 160c that connects with the DMFC stack 42c, out of the three DMFC stacks 42a, 42b and 42c. Thereupon, each of the DMFC stacks 42a and 42b is supplied with air from the air pump 50 at the air supply rate of 1/2, which is 1.5 times as high as the rate for the normal operation, as shown in FIG. 8B.

In this state, the air pump 50 is driven for, e.g., 5 to 15 minutes. Thereupon, air that is introduced through the intake port 49 and pressurized by the pump 50 is run into the respective air passages 147 of the DMFC stacks 42a and 42b (ST5). As this is done, the power generation by the DMFC stacks 42a, 42b and 42c is stopped, and generation of water on the cathode 52 side is also stopped. By running the compressed air into the air passages 147, therefore, the water standing in the passages 147 can be discharged from the DMFC stacks 42a and 42b and delivered to the water recovery tank 55. Thus, air can be smoothly supplied to the cathode 52, so that the reduction of the output of the DMFC stack 42a can be compensated for.

If the necessary air supply rate for the recovery processing for the DMFC stack 42a is about three times as high as the rate for the normal operation, moreover, the microcomputer 95 shifts the four-way valve 156 to the second shift position to close the branch lines 160b and 160c that connect, respectively, with the two DMFC stacks 42b and 42c, out of the three DMFC stacks 42a, 42b and 42c. Thereupon, the DMFC stack 42a is supplied with air at the same rate as the air supply from the air pump 50, that is, at the supply rate three times as high as the rate for the normal operation, as shown in FIG. 8C. In this state, the air pump 50 is driven to run the compressed air into the air passages 147 of the DMFC stack 42a for a predetermined period of time, whereby the DMFC stack 42a whose output is reduced can be recovered preferentially.

During the air supply described above, the power controller 77 detects the output current value of the DMFC stack 42, thereby determining whether or not the output current value is restored to a rated current value (ST6). If the rated value is recovered, the air supply by the air pump 50 is finished (ST7). If not, the power controller 77 determines whether or not a predetermined time period has elapsed since the start of the air supply by the air pump 50 (ST8). When the predetermined time period is up, the air supply by the air pump 50 is finished (ST7).

Thereafter, the power controller 77 closes the switch 102 under the control of the microcomputer 95 of the fuel cell unit 10, thereby starting the power generation of the power generator 40 (ST9). After the passage of a fixed time period since the start of the power generation (ST10), the microcomputer 95 detects the output current value of the DMFC stack 42 after the recovery processing and records it in the EEPROM 99 (ST11). Thereupon, the maintenance mode terminates, and the recovery processing is completed.

In the embodiment described above, the DMFC stack whose output current value is lowered is detected in response to the maintenance start command from the user, and the detected DMFC stack is recovered preferentially. Alternatively, however, the three DMFC stacks 42a, 42b and 42c may be configured to be recovered in the order named without detecting any output current values in response to the maintenance start command from the user. In this case, the air pump 50 is driven at the same air supply rate as in the normal operation, and the four-way valve 156 is successively shifted to the three first or second shift positions with every predetermined time, whereby each of the DMFC stacks 42a, 42b and 42c is supplied with a necessary amount of air.

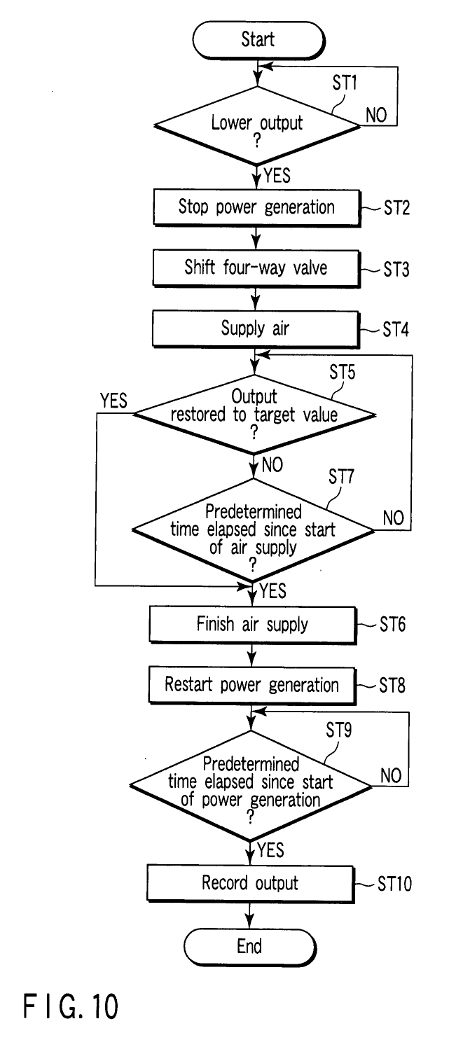

In the embodiment described above, moreover, the recovery processing is performed as required in response to the maintenance start command from the user. Alternatively, however, the information processor 18 may be configured so that its power controller 77 can automatically execute the recovery processing when the outputs of the DMFC stacks 42a, 42b and 42c are reduced. The automatic operation for the recovery processing will now be described with reference to the flowchart of FIG. 10.

While the operation for power generation by the DMFC stacks 42a, 42b and 42c is being performed, the microcomputer 95 of the fuel cell controller 41 monitors the output current values of the stacks 42a, 42b and 42c, stores the detected output current values into the EEPROM 99, and updates them as required. The power controller 77 of the information processor 18 periodically fetches the status information on the fuel cell unit 10 from the EEPROM 99. Then, the controller 77 compares the output current values of the DMFC stacks 42a, 42b and 42c with the preset reference output, e.g., the rated output value in this case, and determines whether or not the output current value of any of the stacks 42a, 42b and 42c is lower than the rated output value (ST1). In the description herein, “periodically” is supposed to imply the concept of “continually.” If any of the output current values is lower by the given or larger margin, the power controller 77 starts the maintenance mode under the control of the CPU 65.

The power controller 77 causes the microcomputer 95 of the fuel cell unit 10 to stop the power generation in the power generator 40 (ST2). The power generation is stopped by, for example, opening the switch 102 to stop the output from the DMFC stacks 42a, 42b and 42c.

After the power generation is stopped, the microcomputer 95 of the fuel cell unit 10, under the control of the power controller 77, drives the air pump 50 of the power generator 40 at the same rotational frequency or air supply rate as in the normal operation, and shifts the four-way valve 156 to the first or second shift position, thereby changing the flow distribution (ST3). If the output current value of the DMFC stack 42a is lowered and if the necessary air supply rate for the recovery processing is about 1.5 times as high as the rate for the normal operation, for example, the microcomputer 95 shifts the four-way valve 156 to the first shift position to close the branch line 160c that connects with the DMFC stack 42c, out of the three DMFC stacks 42a, 42b and 42c. Thereupon, each of the DMFC stacks 42a and 42b is supplied with air from the air pump 50 at the air supply rate of 1/2, which is 1.5 times as high as the rate for the normal operation, as shown in FIG. 8B.

In this state, the air pump 50 is driven for, e.g., 5 to 15 minutes. Thereupon, air that is introduced through the intake port 49 and pressurized by the pump 50 is run into the respective air passages 147 of the DMFC stacks 42a and 42b (ST4). As this is done, the power generation by the DMFC stacks 42a, 42b and 42c is stopped, and generation of water on the cathode 52 side is also stopped. By running the compressed air into the air passages 147, therefore, the water standing in the passages 147 can be discharged from the DMFC stacks 42a and 42b and delivered to the water recovery tank 55. Thus, air can be smoothly supplied to the cathode 52, so that the reduction of the output of the DMFC stack 42a can be compensated for.

If the necessary air supply rate for the recovery processing for the DMFC stack 42a is about three times as high as the rate for the normal operation, moreover, the microcomputer 95 shifts the four-way valve 156 to the second shift position to close the branch lines 160b and 160c that connect, respectively, with the two DMFC stacks 42b and 42c, out of the three DMFC stacks 42a, 42b and 42c. Thereupon, the DMFC stack 42a is supplied with air at the same rate as the air supply from the air pump 50, that is, at the supply rate three times as high as the rate for the normal operation, as shown in FIG. 8C. In this state, the air pump 50 is driven to run the compressed air into the air passages 147 of the DMFC stack 42a for a predetermined period of time, whereby the DMFC stack 42a whose output is reduced can be recovered preferentially.

During the air supply described above, the power controller 77 detects the output current value of the DMFC stack 42, thereby determining whether or not the output current value is restored to a rated current value (ST5). If the rated value is recovered, the air supply by the air pump 50 is finished (ST6). If not, the power controller 77 determines whether or not the predetermined time period has elapsed since the start of the air supply by the air pump 50 (ST7). When the predetermined time period is up, the air supply by the air pump 50 is finished (ST6).

Thereafter, the power controller 77 closes the switch 102 under the control of the microcomputer 95 of the fuel cell unit 10, thereby shifting the four-way valve 156 to the normal operating position and starting the power generation of the power generator 40 (ST8). After the passage of the fixed time period since the start of the power generation (ST9), the microcomputer 95 detects the output current value of the DMFC stack 42 after the recovery processing and records it in the EEPROM 99 (ST10). Thereupon, the maintenance mode terminates, and the recovery processing is completed.

According to the fuel cell system, moreover, the following low-output operation mode or high-output operation mode can be set by controlling the number of DMFC stacks to be operated by swing the four-way valves 154 and 156.

(Low-Output Operation Mode)

Since the response of a fuel cell to an electrical load is so poor that it is usually provided with a capacitor or the secondary battery 80 when the system is constructed. Depending on the state of power generation of the fuel cell unit 10, even these storage mechanisms may possibly fail to process dump power. In this case, the amount of power generation of the fuel cell unit 10 itself must be restricted. If the output of the fuel cell unit 10 that is operating under optimum conditions is restrained by controlling the operating voltage, however, it results in a reduction in efficiency, which is an undesirable factor for the power generation.

In restricting the amount of power generation of the fuel cell system in consideration of low required power, according to the present embodiment, therefore, the power controller 77 sets the low-output operation mode and supplies the fuel and the oxidant (air) to only one or two of the DMFC stacks 42a, 42b and 42c. Thus, the output can be effectively restricted by reducing only the number of DMFC stacks in operation without changing the optimum operating conditions.

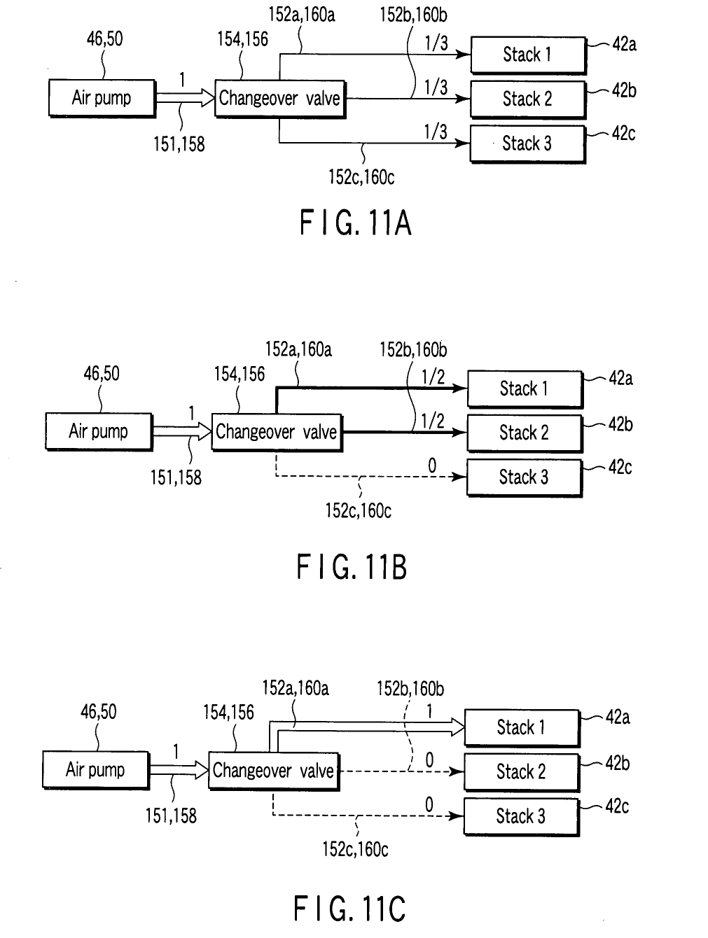

In the normal operation, as shown in FIG. 11A, the liquid pump 46 and the air pump 50 are driven to shift the four-way valve 154 and 156 to their respective normal operating positions. Thereupon, the fuel supplied from the liquid pump 46 is uniformly distributed to the three DMFC stacks 42a, 42b and 42c by the four-way valve 154 and supplied to the anode 47. If the rate of fuel supply from the liquid pump 46 is supposed to be 1, the fuel is equally supplied to each of the DMFC stacks 42a, 42b and 42c at the rate of 1/3.

Likewise, air supplied from the air pump 50 is uniformly distributed to the three DMFC stacks 42a, 42b and 42c by the four-way valve 156. If the rate of air supply from the air pump 50 is supposed to be 1, air is equally supplied to each of the DMFC stacks 42a, 42b and 42c at the rate of 1/3.

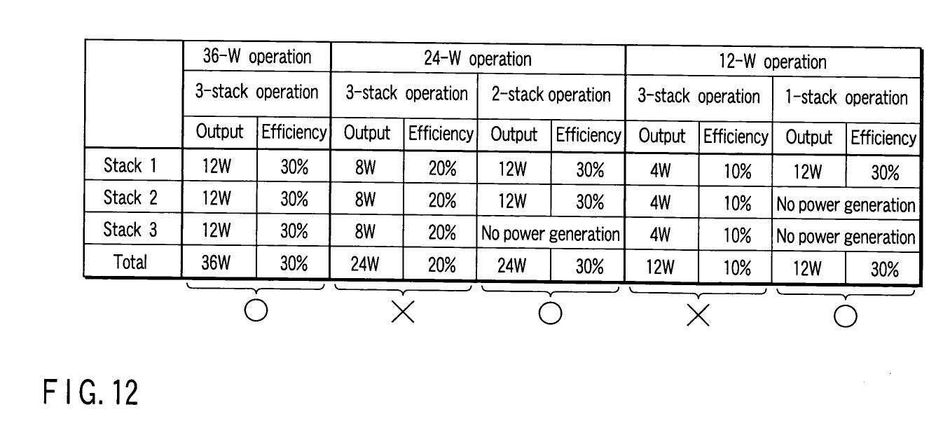

If the amount of power generation of the entire fuel cell system in the normal operation is 36 W, for example, as shown in FIG. 12, each of the DMFC stacks 42a, 42b and 42c generates a power output of 12 W at a power generation efficiency of 30%.

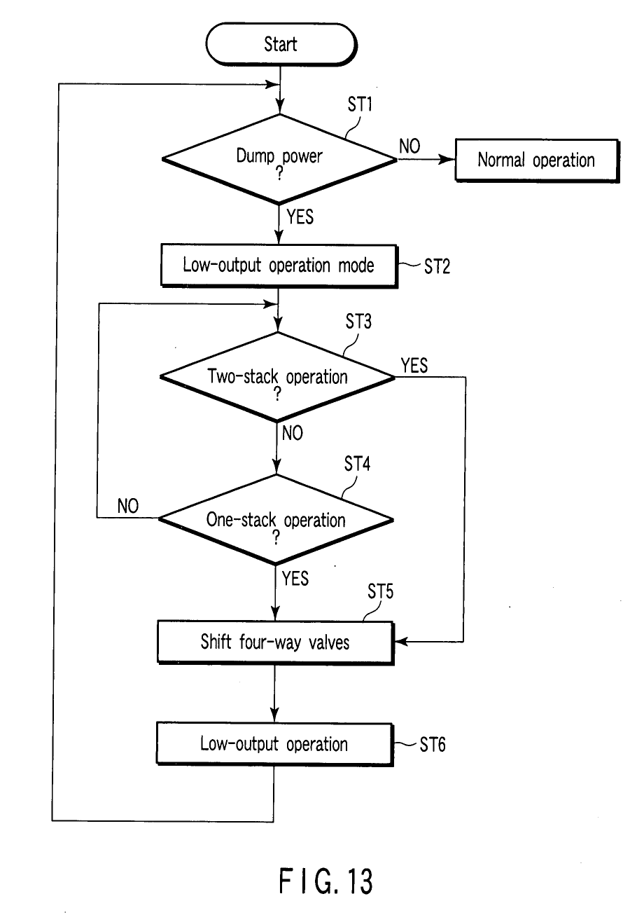

FIG. 13 is a flowchart showing operation in the low-output operation mode. As shown in FIG. 13, the microcomputer 95 of the fuel cell unit 10 sets the low-output operation mode if it detects generation of dump power (ST1) under the control of the power controller 77. Subsequently, two-stack operation (or 24-W operation) or one-stack operation (12-W operation) is selected depending on the state of the dump power (ST3 and ST4).

If the two-stack operation is selected, the microcomputer 95 operates the liquid pump 46 and the air pump 50 of the power generator 40 at the same rotational frequencies or fuel and air supply rates as in the normal operation, and shifts the four-way valves 154 and 156 to their respective first shift positions, thereby changing the flow distribution (ST5), as shown in FIGS. 11B and 12. For example, the microcomputer 95 shifts the four-way valve 154 to the first shift position to close the branch line 152c that connects with the DMFC stack 42c, out of the three DMFC stacks 42a, 42b and 42c. Further, the microcomputer 95 shifts the four-way valve 156 to the first shift position to close the branch line 160c that connects with the one DMFC stack 42c.

Each of the DMFC stacks 42a and 42b is supplied with the fuel from the liquid pump 46 at the rate of 1/2 and with air from the air pump 50 at the rate of 1/2. Thereupon, each of the DMFC stacks 42a and 42b generates a power output of 12 W at an operating efficiency of 30%, that is, the entire system performs low-output operation (ST6) for 24-W power generation.

Thus, only two of the DMFC stacks 42a, 42b and 42c are operated at the normal efficiency without reducing the output of each of the three DMFC stacks to 8 W (at an operating efficiency of 20%). By doing this, the output can be restricted without lowering the efficiency of power generation.

If the one-stack operation is selected in ST4, the microcomputer 95 operates the liquid pump 46 and the air pump 50 of the power generator 40 at the same rotational frequencies or fuel and air supply rates as in the normal operation, and shifts the four-way valves 154 and 156 to their respective second shift positions, thereby changing the flow distribution (ST5), as shown in FIGS. 11C and 12. For example, the microcomputer 95 shifts the four-way valve 154 to the second shift position to close the branch lines 152b and 152c that connect, respectively, with the two DMFC stack 42b and 42c, out of the three DMFC stacks 42a, 42b and 42c. Likewise, the microcomputer 95 shifts the four-way valve 156 to the second shift position to close the branch lines 160b and 160c that connect with the two DMFC stacks 42b and 42c, respectively.

Thereupon, the fuel and air supply to the DMFC stacks 42b and 42c is stopped, and the fuel is supplied to only the DMFC stack 42a at the same rate as the fuel from the liquid pump 46. Thus, the DMFC stack 42a generates a power output of 12 W at an operating efficiency of 30%, that is, the entire system performs low-output operation (ST6) for 24-W power generation.

Thus, only one of the DMFC stacks 42a, 42b and 42c is operated at the normal efficiency without reducing the output of each of the three DMFC stacks to 4 W (at an operating efficiency of 10%). By doing this, low-output operation can be performed without lowering the efficiency of power generation.

(Long-Life Operation Mode)

When employing the fuel cell system mounted with a plurality of DMFC stacks for a long period of time, it is desirable to preferentially use DMFC stacks with higher power generation performance so that the DMFC stacks can be uniformly lowered in performance, in consideration of the ease of electrical control and maintenance such as parts replacement. The use of the DMFC stacks with higher power generation performance is also advantageous to the power generation efficiency.

In performing the aforementioned low-output operation and the like, according to the present embodiment, therefore, the microcomputer 95 of the fuel cell controller 41 monitors the output current values of the stacks 42a, 42b and 42c, stores the detected output current values into the EEPROM 99, and updates them as required. The power controller 77 of the information processor 18 periodically fetches the status information on the fuel cell unit 10 from the EEPROM 99 and detects the DMFC stack with the highest power generation performance based on the output current values of the DMFC stacks 42a, 42b and 42c. In performing the aforementioned low-output operation mode or the like, the microcomputer 95 supplies the fuel and air to only the DMFC stack with the highest power generation performance, out of the three DMFC stacks 42a, 42b and 42c, thereby actuating only that DMFC stack for power generation. Thus, the plurality of DMFC stacks are allowed to be uniformly lowered in performance, so that the fuel cell system can enjoy advantageous operation with respect to its life performance and power generation efficiency.

According to the fuel cell system constructed in this manner and its operation control method, the single liquid pump and the single air pump are provided for the plurality of DMFC stacks, and optimum operation can be performed with the flow distribution of the fuel and air to the DMFC stacks changed by means of switching valves, i.e., the four-way valves in this case, located between the pumps and the DMFC stacks. When compared with the case of a configuration in which each DMFC stack is provided with an accessory such as a pump, the number of accessories including the pumps can be reduced, so that the control can be simplified, and the apparatus can be reduced in size.

The air supply line is switched by means of the switching valves, and the air flow rate is made higher than in the normal operation, whereby output recovery operation can be performed efficiently. During this output recovery operation, the air pump is expected only to be driven at the same rotational frequency as in the normal operation, and there is no need of any pump that is provided with extra specifications for the output recovery operation. Thus, miniaturization of the entire apparatus, reduction of noise, and the like can be achieved. Further, only that DMFC stack which is subjected to a significant reduction in output can be recovered preferentially, so that high-efficiency operation can be performed as a whole.

Since the fuel and air supply lines are switched by means of the switching valves, high-efficiency operation can be realized to drive only some of the DMFC stacks. Accordingly, low-output or long-life operation can performed without lowering the operating efficiency.

Thus, there may be provided a fuel cell system and its operation control method, in which a reduction of the output of the fuel cell can be efficiently compensated for without increasing the size of the apparatus and low-output operation can be performed without lowering the efficiency of power generation.

While certain embodiments of the invention have been described, these embodiments have been presented by way of example only, and are not intended to limit the scope of the invention. Indeed, the novel methods and systems described herein may be embodied in a variety of forms. Furthermore, various omissions, substitutions and changes in the form of the methods and systems described herein may be made without departing from the spirit of the invention. The accompanying claims and their equivalents are intended to cover such forms or modifications as would fall within the scope and spirit of the invention.

Although the fuel cell unit is configured to be connected to the outside of the information processor, for example, it may alternatively be contained in the information processor. The number of DMFC stacks in the fuel cell unit is not limited to three but may alternatively be two or four or more. The air supply rate, operating time, etc. of the air pump in the recovery processing are not limited to the values according to the foregoing embodiment, but may be variously selected.

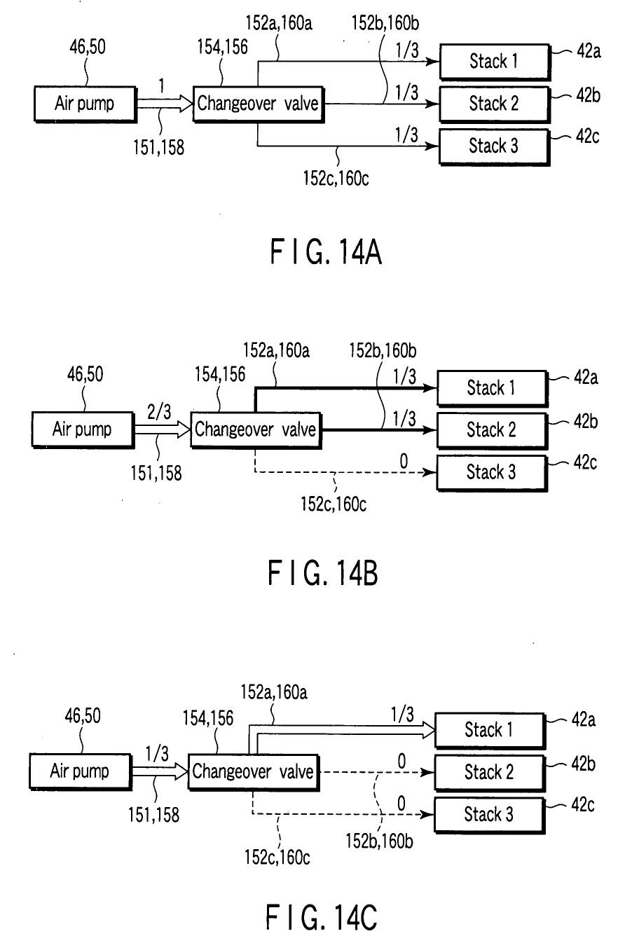

In the embodiment described above, pumps with fixed flow rates are used for the air pump and the liquid pump. Alternatively, however, variable-flow valves may be used for this purpose. FIGS. 14A, 14B, 14C show flow distribution for the case where the low-output operation mode is carried out using the liquid pump 46 and the air pump 50 with variable flow rates.

In the normal operation, as shown in FIG. 14A, the liquid pump 46 and the air pump 50 are driven to shift the four-way valve 154 and 156 to their respective normal operating positions. Thereupon, the fuel supplied from the liquid pump 46 is uniformly distributed to the three DMFC stacks 42a, 42b and 42c by the four-way valve 154 and supplied to the anode 47. If the rate of fuel supply from the liquid pump 46 is supposed to be 1, the fuel is equally supplied to each of the DMFC stacks 42a, 42b and 42c at the rate of 1/3. Likewise, air supplied from the air pump 50 is uniformly distributed to the three DMFC stacks 42a, 42b and 42c by the four-way valve 156. If the rate of air supply from the air pump 50 is supposed to be 1, air is equally supplied to each of the DMFC stacks 42a, 42b and 42c at the rate of 1/3.

If the two-stack operation in the low-output operation mode is selected, the microcomputer 95 operates the liquid pump 46 and the air pump 50 of the power generator 40 at fuel and air supply rates equal to 2/3 of those for the normal operation, and shifts the four-way valves 154 and 156 to their respective first shift positions, thereby changing the flow distribution, as shown in FIG. 14B. For example, the microcomputer 95 shifts the four-way valve 154 to the first shift position to close the branch line 152c that connects with the DMFC stack 42c, out of the three DMFC stacks 42a, 42b and 42c. Further, the microcomputer 95 shifts the four-way valve 156 to the first shift position to close the branch line 160c that connects with the one DMFC stack 42c. Thereupon, each of the DMFC stacks 42a and 42b is supplied with the fuel from the liquid pump 46 at the fuel supply rate of 1/3 or half of 2/3 and air from the air pump 50 at the air supply rate of 1/3 or half of 2/3.

If the one-stack operation in the low-output operation mode is selected, the microcomputer 95 operates the liquid pump 46 and the air pump 50 of the power generator 40 at fuel and air supply rates equal to 1/3 of those for the normal operation, and shifts the four-way valves 154 and 156 to their respective second shift positions, thereby changing the flow distribution, as shown in FIG. 14C. For example, the microcomputer 95 shifts the four-way valve 154 to the second shift position to close the branch lines 152b and 152c that connect, respectively, with the two DMFC stack 42b and 42c, out of the three DMFC stacks 42a, 42b and 42c. Further, the microcomputer 95 shifts the four-way valve 156 to the second shift position to close the branch lines 160b and 160c that connect with the two DMFC stacks 42b and 42c, respectively. Thereupon, the DMFC stack 42a is supplied with the fuel from the liquid pump 46 at the fuel supply rate of 1/3 and air from the air pump 50 at the air supply rate of 1/3.

Also with this arrangement, the low-output operation can be performed without lowering the power generation efficiency of the DMFC stacks 42a, 42b and 42c.

In the foregoing embodiment, a first valve mechanism is provided with the four-way valve that is located at the junction between the main passage 151 and the branch lines 152a, 152b and 152c of the fuel supply line. Likewise, a second valve mechanism is provided with the four-way valve that is located at the junction between the main passage 158 and the branch lines 160a, 160b and 160c of the air supply line. However, the valve mechanisms are not limited to those configurations, but independent on-off valves may be provided individually at the junctions so that they can be controlled independently as they are opened or closed.

Besides, the fuel cell system according to this invention is not limited to the personal computer described herein, but may be also applied to any other electronic devices, such as mobile devices, portable terminals, etc. The fuel cell may be a polymer electrolyte fuel cell (PEFC) or any other type than a DMFC.

What is claimed is:

1. A fuel cell system comprising:
a plurality of cell stacks, each of which includes a plurality of single cells, stacked in layers on one another and each including an anode and a cathode opposed to each other, a fuel passage through which a fuel is supplied to the anode, and an air passage through which air is supplied to the cathode, and generates electric power based on a chemical reaction;
an air pump which supplies air to the plurality of cell stacks;
a valve mechanism which is provided between the air pump and the air passage of each cell stack and switches a flow distribution of air from the air pump to each cell stack; and
a power controller which shifts the valve mechanism to change the flow distribution to the plurality of cell stacks.

2. The fuel cell system according to claim 1, which further comprises a fuel cell controller which shifts the valve mechanism to stop air supply from the air pump to at least one of the cell stacks and distribute air from the air pump to the other cell stacks and recover the other cell stacks.

3. The fuel cell system according to claim 2, wherein the fuel cell controller is provided with means for recovering the cell stacks in order.

4. The fuel cell system according to claim 1, which further comprises a detecting section which detects a generated power output of each of the cell stacks and a fuel cell controller which shifts the valve mechanism to stop an air flow distribution to other cell stacks than a cell stack whose generated power output detected by the detecting section is lower than a predetermined generated power output, if any, and distribute air from the air pump to only the cell stack whose generated power output is lower, to recover the cell stack concerned.

5. The fuel cell system according to claim 1, which further comprises an air supply line through which air is supplied from the air pump to the plurality of cell stacks, the air supply line including a main passage extending from the air pump and a plurality of branch lines diverging from the main passage and extending individually to the cell stacks, and wherein the valve mechanism comprises a switching valve which is provided at a junction between the main passage and the branch lines and switches a flow distribution from the main passage to the branch lines.

6. A fuel cell system comprising:
a plurality of cell stacks, each of which includes a plurality of single cells, stacked in layers on one another and each including an anode and a cathode opposed to each other, a fuel passage through which a fuel is supplied to the anode, and an air passage through which air is supplied to the cathode, and generates electric power based on a chemical reaction;
a liquid pump which supplies the fuel to the plurality of cell stacks;
an air pump which supplies air to the plurality of cell stacks;
a first valve mechanism which is provided between the liquid pump and the fuel passage of each cell stack and switches a flow distribution of the fuel from the liquid pump to each cell stack;
a second valve mechanism which is provided between the air pump and the air passage of each cell stack and switches a flow distribution of air from the air pump to each cell stack; and
a power controller which shifts the first and second valve mechanisms to change the flow distributions of the fuel and air from the liquid pump and the air pump to the plurality of cell stacks.

7. The fuel cell system according to claim 6, which further comprises a fuel cell controller which causes the first and second valve mechanisms to stop fuel and air supply from the liquid pump and the air pump to at least one of the cell stacks and distribute the fuel and air from the liquid pump and the air pump to the other cell stacks, thereby performing low-output operation based on power generation by the other cell stacks only.

8. The fuel cell system according to claim 6, which further comprises a detecting section which detects a generated power output of each of the cell stacks and a fuel cell controller which selects a cell stack whose generated power output detected by the detecting section is the highest and causes the first and second valve mechanisms to distribute the fuel and air from the liquid pump and the air pump to only the cell stack whose generated power output is the highest and stop fuel and air distributions to the other cell stacks, thereby performing low-output operation based on power generation by the highest-output cell stack only.

9. A method of controlling an operation of a fuel cell system, which comprises a plurality of cell stacks, each of which includes a plurality of single cells, stacked in layers on one another and each including an anode and a cathode opposed to each other, a fuel passage through which a fuel is supplied to the anode, and an air passage through which air is supplied to the cathode, and generates electric power based on a chemical reaction, an air pump which supplies air to the plurality of cell stacks, a valve mechanism which is provided between the air pump and the air passage of each cell stack and switches a flow distribution of air from the air pump to each said cell stack, and a power controller which shifts the valve mechanism to change the flow distribution to the plurality of cell stacks, the method comprising:
uniformly distributing the air from the air pump to the plurality of cell stacks during normal operation, thereby performing operation for power generation; and
shifting the valve mechanism to stop air supply from the air pump to at least one of the cell stacks during recovery processing and distributing the air from the air pump to the other cell stacks only, to recover the other cell stacks.

10. The method according to claim 9, which further comprises detecting a generated power output of each of the cell stacks and shifting the valve mechanism to stop an air flow distribution to other cell stacks than a cell stack whose detected generated power output is lower than a predetermined generated power output, if any, and distribute air from the air pump to only the cell stack whose generated power output is lower, to recover the cell stack concerned.
